(19) United States
(12) Patent Application Publication
(10) Pub. No.: US 2026/0112523 A1
(43) Pub. Date: Apr. 23, 2026

(54) SURGE ARRESTER FOR HIGH OR MEDIUM VOLTAGE

(71) Applicant: Hitachi Energy Ltd, Zürich (CH)

(72) Inventors: TianSong Chen, Xiamen (CN); Yun Zhang, Xiamen (CN); ShuYu Li, Beijing (CN)

(21) Appl. No.: 19/147,739

(22) PCT Filed: Jan. 16, 2023
(86) PCT No.: PCT/EP2023/050894

§ 371 Date: Jul. 14, 2025

(51) Int. Cl. H01C 7/12; H01C 7/18

(52) U.S. Cl. CPC H01C 7/12; H01C 7/18

(57) ABSTRACT

A surge arrester for high or medium voltage includes two end electrodes, arrester elements of metal oxide varistor material, at least one reinforcement rod for axial compression of the arrester elements arranged in between the two electrodes in axial direction, and a clamping arrangement for anchoring the end electrodes to the reinforcement rod, wherein the reinforcement rod includes in an end region of the reinforcement rod a groove for engaging with a retaining ring of the clamping arrangement.

### CROSS REFERENCE TO RELATED APPLICATION

This application is a 35 U.S.C. § 371 national stage application of PCT International Application No. PCT/EP2023/050894 filed on Jan. 16, 2023, the disclosure and content of which is incorporated by reference herein in its entirety.

### TECHNICAL FIELD

The present disclosure relates to a surge arrester for high or medium voltage.

### BACKGROUND

High or medium voltage devices, such as circuit breakers and surge arresters are essential for the protection of technical equipment, especially in the high voltage range. For example, surge arresters are connected between live lines and ground in power supply systems in order to dissipate a surge in the line, to ground and thus to protect other components in the power supply system. Surge arresters are typically used to protect the insulation of gas-insulated switchgear as well as the connecting cables and transformers against transient lightning and switching overvolt-ages. Surge arresters are capable of dissipating surges occurring within the range for which the surge arresters are designed safely and as often as necessary to ground.

A surge arrester typically contains a stack of arrester elements, which is held between two electrodes. This arrangement may be accommodated in an outer housing. The arrester elements have the property that their electrical resistance is volt-age-dependent. This means that the arrester elements are good insulators below a threshold voltage. Above the threshold voltage, however, they are good electrical conductors.

In the case of lightning strike close to an arrester or a flaw in a high-voltage line, it may come to pass that a surge arrester is subjected to a load which is far greater than its design range. This results in a solid-state flashover through the block of arrester elements and may give irreversible damage to the surge arrester. In such an event a large amount of energy becomes free, which is associated with a high increase in temperature and pressure. In order that the surroundings are not harmed in such an event, it is necessary that no large fragments, either from the outer housing or from the material of the arrester elements, are thrown far away from the surge arrester.

With regard to the outer housing of surge arresters two different concepts are known in prior art. There are surge arresters with a “tubular design”, in which the active components are accommodated in a tube, for example made from ceramic or a dimensionally stable plastic. In this case, a gas volume remains in the interior of the outer housing. The outer housing of these surge arresters may be provided with a gas outlet opening, through which the hot plasma can emerge in the event of an overload, as a result of which an increase in pressure in the interior of the outer housing is prevented. In the case of such surge arresters, the outer housing itself generally remains undamaged even in the case of an overload.

As alternative there are surge arresters in which the outer housing is cast or injection-moulded directly around the active components. For this purpose, a high-quality plastic, usually silicone, is used.

In order to ensure that the arrester elements stacked in axial direction are in good contact with one another even in the case of mechanical loads, it is necessary in both cases to keep the stack of arrester elements together under pressure. One possibility for this, which is used both in surge arresters with a tubular design and in those with an outer housing which is attached by injection-moulding, is to provide reinforcement rods, which are held under strain on the end electrodes. Typically, these surge arresters are also referred to as surge arresters with a cage-type design.

Another possibility for providing the axial compression between the arrester elements is the so-called loop-type design. For the loop-type design electrically insulating compression loops are wound around the stack in an axial manner and are embedded in a thermosetting resin. The compression loops are clamped to the end electrodes. However, the production procedure of surge arresters having a loop design is complex and expensive. Furthermore, the complex procedure makes it difficult to provide a high production quality.

For surge arresters having reinforcement rods, it is common to machine a screw thread on the end of the reinforcement rods which engage with a corresponding screw nut for attaching the reinforcement rod to the end electrode and for providing the axial compression. However, the screw thread on the end of the reinforcement rod decreases the mechanical strength of the rod. Furthermore, the design with the reinforcement rods does not allow to compensate for a temperature induced axial increase or decrease of the arrester elements. The weakening of the reinforcement rod and the mechanical inflexibility of the cage can cause damage to the reinforcement rod or the arrester element themselves. Therefore, there is a need to increase the mechanical stability of the surge arrester.

### SUMMARY

It is an object of the present disclosure to improve the mechanical stability of surge arresters. It is further an object of the present disclosure to provide means for reducing damage to the reinforcement rod.

The object of the present disclosure is at least solved in part by the features of the independent claims. Modified embodiments are detailed in the dependent claims.

Thus, the object is solved by a surge arrester for high or medium voltage comprising two end electrodes, arrester elements of metal oxide varistor material, at least one reinforcement rod for axial compression of the arrester elements arranged in between the two electrodes in axial direction, and a clamping arrangement for anchoring the end electrodes to the reinforcement rod, wherein the reinforcement rod comprises in an end region of the reinforcement rod a groove for engaging with a retaining ring of the clamping arrangement, and wherein the surge arrester comprises for each reinforcement rod an element for compensating thermal expansion of the arrester elements.

One aspect of the present disclosure is that the surge arrester comprises the clamping arrangement for anchoring the end electrodes to the reinforcement rods. The clamping arrangement comprises the retaining ring, which engages with the groove in the reinforcement rod. The groove in the reinforcement rod does not impair the mechanical stability of the reinforcement rod, as the screw thread known from prior art. Hence, the mechanical stability of the surge arrester is enhanced.

The reinforcement rod may be made of an insulating material, such as a glass fiber reinforced plastic. As the surge arrester comprises arrester elements of metal oxide varistor material, it is a metal oxide surge arrester. In the context of the present disclosure medium to high voltages means voltages of 5 kV up to 1200 kV.

The reinforcement rod, having the form of a bar, has two end regions, which are preferably the last 20% of the length of the rod. In some embodiments, the reinforcement rod has in both end regions a groove—or in other words the reinforcement rod has preferably two grooves.

In some embodiments, at least one of the end electrodes comprises means for connecting the electrode to the power supply system. In some embodiments, the electrode comprises a central screw and/or a central opening for connecting the surge arrester to the power supply system. In some embodiments, the central opening is configured as through hole.

According to an embodiment of the present disclosure the reinforcement rod is in the end region of the reinforcement rod free of a screw thread. In other words, Instead, of a screw thread for attaching the reinforcement rod to the end electrodes as known from prior art, the reinforcement rod comprises the groove and the clamping arrangement. Preferably both end regions of the reinforcement rod are free of a screw thread. In some embodiments, the reinforcement rod is entirely free of screw thread. This ensures a high mechanical stability of the reinforcement rod and thus of the surge arrester.

Furthermore, not only the reinforcement rod may be free of a screw thread, but also the clamping arrangement may be free of a screw nut. In some embodiments, the anchoring of the reinforcement rod to the end electrode and preferably the clamping arrangement is threadless.

According to another embodiment of the present disclosure, a surge arrester is provided, wherein the arrester elements are arranged as a stack in axial direction in between the two end electrodes, and wherein a spacer element is arranged in between the end electrode and the stack. In some embodiments, the spacer is in direct contact to the end electrode and preferably to the arrester element. In some embodiments, the surge arrester comprises a spacer element on both ends of the stack of arrester elements. The spacer element may ensure a good electrical contact between the electrode and the stack of arrester elements.

According to another embodiment of the present disclosure the surge arrester comprises multiple reinforcement rods, the reinforcement rods connect the two end electrodes in axial direction with each other and surround the arrester elements arranged in between the two electrodes. In other words, the reinforcement rods do preferably not run through the arrester elements and/or are preferably not within the arrester elements, but are outside of the arrester elements.

In an alternative embodiment of the present disclosure the surge arrester comprises one reinforcement rod, the reinforcement rod connects the two end electrodes in axial direction with each other and runs through the arrester elements. In other words, in this embodiment the reinforcement rod resides within the arrester elements.

Independent of having one or multiple reinforcement rods, and according to another embodiment of the present disclosure, the end electrode comprises at least one through holes through which the reinforcement rod runs, such that the groove of the reinforcement rod is positioned on the side of the end electrode facing away from the arrester elements arranged in between the two electrodes. In such a way the plurality of the reinforcement rods, the clamping arrangement and the two electrodes provide the axial compression onto the arrester elements needed for good contact with one another.

In case the surge arrester comprises multiple reinforcement rods, the end electrode may comprise along a circumference a plurality of through holes through which the plurality of reinforcement rods run, such that the groove of the reinforcement rod is positioned on the side of the end electrode facing away from the arrester elements arranged in between the two electrodes.

In case the surge arrester comprises one reinforcement rod, the end electrode may comprise a central through hole through which the one reinforcement rod runs, such that the groove of the reinforcement rod is positioned on the side of the end electrode facing away from the arrester elements arranged in between the two electrodes.

With regard to the clamping arrangement the clamping arrangement comprises the retaining ring. The retaining ring may be arranged in the groove of the reinforcement rod.

It is possible that the clamping arrangement includes the retaining ring. In this regard and according to an embodiment of the present disclosure, the retaining ring is in direct contact to the electrode and particular preferably to the side of the electrode facing away from the arrester elements arranged in between the two electrodes.

However, in connection with the clamping arrangement and according to another embodiment of the present disclosure the clamping arrangement comprises the retaining ring and an annular fitting, and with regard to the axial direction, the annular fitting is arranged in between the retaining ring and the electrode. In some embodiments, the annular fitting is in direct contact to the retaining ring. In some embodiments, the annular fitting is arranged on the side of the end electrode facing away from the arrester elements arranged in between the two electrodes.

In some embodiments, the annular fitting engages around the reinforcement rod, directly adjacent to the retaining ring, which in turn is engaged in the groove of the reinforcement rod. In some embodiments, the annular fitting comprises a first support area for supporting the retaining ring, wherein the first support area faces in axial direction and away of the arrester elements arranged in between the two electrodes. In some embodiments, the annular fitting comprises a second support area facing in radial direction for supporting the retaining ring. In some embodiments, the annular fitting comprises a third support area preferably parallel to the first support area, wherein the third support area faces towards the arrester elements arranged in between the two electrodes.

With regard to the end electrodes, the electrodes may comprise around the through hole through which the reinforcement rod runs, elements for radial support for the retaining ring and/or annular fitting. In particular, the electrodes may comprise around the through hole through which the reinforcement rod runs, a blind hole, such that the through hole is arranged in the center of the blind hole, and wherein a diameter of the blind hole is larger than a diameter of the through hole. By this configuration, sidewalls of the blind hole act as elements for radial support. In particular, a diameter of the blind hole may correspond to an outer diameter of the annular fitting or the outer diameter of the retaining ring.

Regarding the element for compensating thermal expansion of the arrester elements in axial direction, the element for compensating thermal expansion of the arrester elements may be a spring. This has the advantages that at least part of the force acting on the reinforcement rod and created by an increase in volume of the arrester element due to a temperature change, is received by the spring. Hence, the risk that the reinforcement rods or the arrester elements are damaged by thermal expansion of the arrester element is decreased. Thus, a mechanically more robust surge arrester is provided.

In connection to this and according to another embodiment of the present disclosure, the surge arrester comprises a plurality of elements for compensating thermal expansion of the arrester elements, and wherein the element for compensating thermal expansion of the arrester elements is arranged on the side of the end electrode facing away from the arrester elements arranged in between the two electrodes. This has the advantage that a fine-tuning of the compensation is more easily achievable compared to one element for compensating the thermal expansion. Furthermore, as the spring is wound around the reinforcement rod, it is held in place by the reinforcement rod.

According to the present disclosure, the surge arrester comprises for each reinforcement rod an element for compensating thermal expansion of the arrester elements. In some embodiments, all elements for compensating thermal expansion are arranged beside the same end electrode, preferably the end electrode, that is configured to engage with the power supply systems.

According to another embodiment of the present disclosure, the element for compensating thermal expansion of the arrester elements is arranged in between the end electrode and the clamping arrangement. In some embodiments, the element for compensating thermal expansion of the arrester elements is in direct contact with the end electrode and with the annular fitting of the clamping arrangement. In some embodiments, the third support area of the annular fitting is in direct contact to the element for compensating thermal expansion of the arrester elements. In some embodiments, a bottom of the blind hole is also in direct contact to the element for compensating thermal expansion of the arrester elements.

It is not only possible to arrange the elements for compensating thermal expansion of the arrester elements on the side of the end electrode facing away from the arrester elements arranged in between the two electrodes. According to a further embodiment of the present disclosure, the plurality of elements for compensating thermal expansion of the arrester elements are arranged on the side of the end electrode facing towards the arrester elements arranged in between the two electrodes.

Furthermore, arranging the elements for compensating thermal expansion of the arrester elements on the side of the end electrode facing towards the arrester elements, makes it also possible to use only one element for compensating the thermal expansion of the arrester elements. In this regard and according to a further embodiment of the present disclosure, the element for compensating thermal expansion of the arrester elements is arranged on the side of the end electrode facing towards the arrester elements arranged in between the two electrodes. In some embodiments, the element for compensating thermal expansion of the arrester elements is in direct contact with the electrode and preferably in direct contact with a connecting element arranged next to the arrester element. The connecting element not only provides a support area for the element for compensating thermal expansion, but is also configured to provide electrical connection to the electrode. In this regard the end electrode may comprise the central through hole and a pin arranged in the central through hole, such that the pin is axially displaceable with respect to the electrode. The pin is further connected to the connecting element being arranged on the arrester element. The element for compensating thermal expansion may be wound around the pin.

According to another embodiment of the present disclosure, a surge arrester is provided, wherein the surge arrester comprises at least one stabilizing disc in between two arrester elements, wherein the stabilizing disc comprises a through holes through which the reinforcement rod run. In case the surge arrester comprises multiple reinforcement rods, the stabilizing disc may comprise along a circumference a plurality of through holes through which the plurality of reinforcement rods run. In some embodiments, the reinforcement rod, and particularly a diameter of the reinforcement rod, and the through hole of the stabilizing disc, and particularly a diameter of the through hole, are such that the reinforcement rod is movable in axial direction. This ensures the mechanical flexibility needed for compensating thermal expansion of the arrester element.

With regard to the arrester element, and according to another embodiment of the present disclosure, the arrester elements have a cylindrical or polygonal form. In some embodiments the surge arrester comprises multiple reinforcement rods, the arrester elements are preferably free of a through hole. Being free of a through hole also means that there is no reinforcement rod running through the arrester element. In some embodiments the surge arrester comprises one reinforcement rod, the arrester elements preferably comprise a central through hole.

With regard to the material of the arrester elements and as already mentioned, the arrester elements are of a metal oxide varistor material. In this regard and according to another embodiment of the present disclosure, the metal oxide varistor material comprises ZnO. In some embodiments, the metal oxide varistor material further comprises additives of one or more oxides and/or carbonates of Bi, Sb, Cr, Mn, Co, Ni, Si, B, Ba, Pb, Al. In some embodiments, the metal oxide varistor material comprise ZnO in an amount of 70 mol % to 95 mol % and preferably the additive in an amount of 30 mol % to 5 mol %.

According to another embodiment of the present disclosure, the surge arrester comprises an outer housing, preferably such that a gas volume remains in the interior of the outer housing. In some embodiments, the outer housing comprises porcelain, plastic or a metal.

In some embodiments, the gas volume is formed by an insulation gas. In some embodiments, the insulation gas is selected from SF₆, CO₂, mixtures comprising CO₂, mixtures of SF₆ with a carrier gas and/or mixtures of fluoroketons and/or fluoronitriles with a carrier gas. The carrier gas for use with SF₆, fluoroketons and/or fluoronitriles may comprise air, N₂, CO₂, and mixtures thereof. In some embodiments, the insulation gas may have a reduced fluorine content compared to SF₆ or may even be fluorine free.

These and other aspects of the present disclosure will be apparent from and elucidated with reference to the embodiments described hereinafter.

### BRIEF DESCRIPTION OF THE DRAWINGS

### In the Drawings:

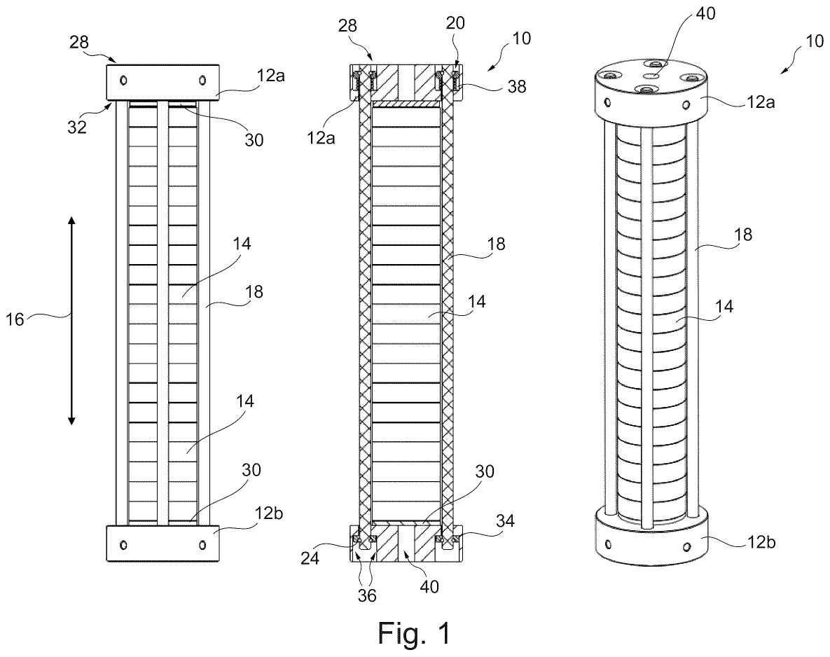

FIG. 1 schematically shows different views of a surge arrester according to an embodiment of the present disclosure,

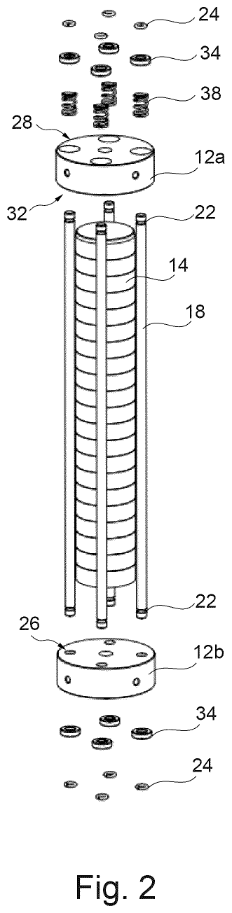

FIG. 2 schematically shows an exploded view of the surge arrester of FIG. 1,

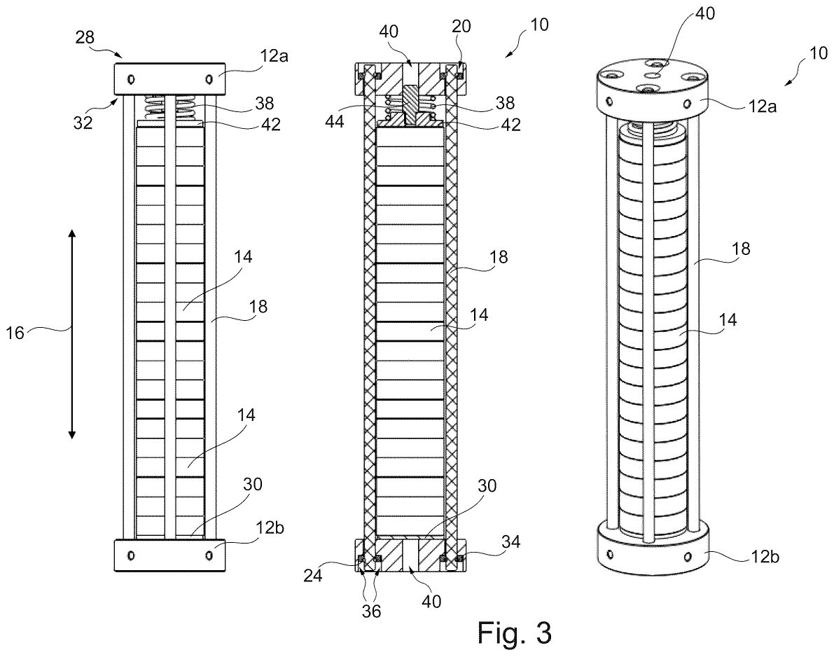

FIG. 3 schematically shows different views of a surge arrester not falling under the scope of the independent claim,

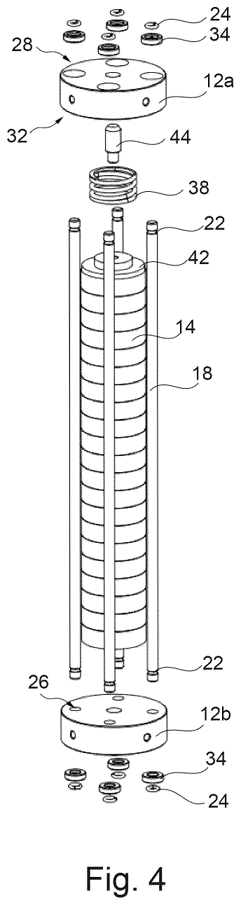

FIG. 4 schematically shows an exploded view of the surge arrester of FIG. 3,

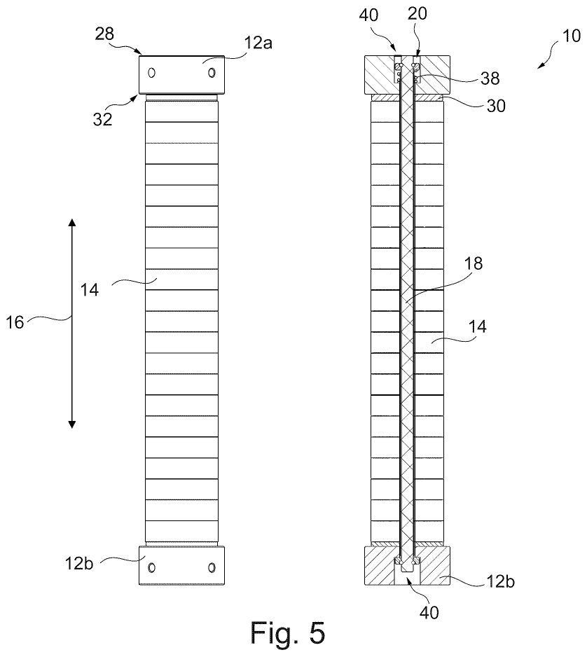

FIG. 5 schematically shows different views of a surge arrester according to another embodiment of the present disclosure, and

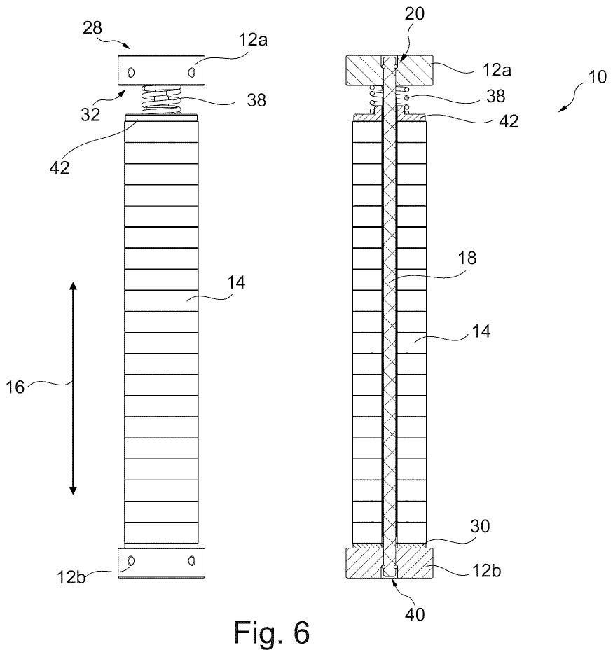

FIG. 6 schematically shows a view of a surge arrester according to a further embodiment of the present disclosure.

### DETAILED DESCRIPTION

FIGS. 1 and 2 schematically show different views of a surge arrester 10 according to an embodiment of the present disclosure. The surge arrester 10 comprises two end electrodes 12a, 12b, and arrester elements 14 of metal oxide varistor material, which are arranged in between the two electrodes 12a, 12b in axial direction 16. The surge arrester 10 further comprises multiple reinforcement rods 18 for axial compression of the arrester elements 14 and a clamping arrangement 20 for anchoring the end electrodes 12a, 12b to the reinforcement rods 18. The reinforcement rods 18 connect the two end electrodes 12a, 12b in the axial direction 16 with each other and surround the arrester elements 14 arranged in between the two electrodes 12a, 12b.

With regard to the clamping arrangement 20, it can be seen in FIG. 2, that the reinforcement rod 18 comprises in an end region of the reinforcement rod 18 a groove 22 for engaging with a retaining ring 24 of the clamping arrangement 20. Thus, the reinforcement rod 18 is free of a screw thread.

As best seen in the sectional view in FIG. 1, the end electrode 12a, 12b comprises along a circumference a plurality of through holes 26 through which the plurality of reinforcement rods 18 run, such that the groove 22 of the reinforcement rod 18 is positioned on the side 28 of the end electrode 12a, 12b facing away from the arrester elements 14.

Furthermore, in between each of the two end electrodes 12a, 12b, and the arrester element 14, there is a spacer element 30 arranged, which is in direct contact to the side 32 of the electrode facing towards the arrester elements 14.

The clamping arrangement 20 further comprise an annular fitting 34, which is with regard to the axial direction 16 arranged in between the retaining ring 24 and the electrode 12a, 12b. The annular fitting 34 engages around the reinforcement rod 18, directly adjacent to the retaining ring 24, which in turn is engaged in the groove 22 of the reinforcement rod 18. With regard to the end electrodes 12a, 12b, they comprise around the through holes 26 sidewalls 36, as elements for radial support for the annular fitting 34.

As can further be seen in FIGS. 1 and 2, the surge arrester 10 further comprises a plurality of elements 38 for compensating thermal expansion of the arrester elements 14 in axial direction 16. These elements 38 are configured as springs 38 and are wound around the reinforcement rod 18. In the embodiment shown in FIGS. 1 and 2, the springs 38 are arranged on the side 28 of the end electrode 12a facing away from the arrester elements 14. The springs 38 are each arranged in between the end electrode 12a and the clamping arrangement 20. The spring 38 is in direct contact with the end electrode 12a and with the annular fitting 34 of the clamping arrangement 20.

As can also be seen in FIGS. 1 and 2, is that the end electrodes 12a, 12b comprise a central opening 40 configured as through hole.

FIGS. 3 and 4 schematically show different views of a surge arrester 10 not falling under the scope of the independent claim. This exemplary surge arrester 10 is similar to the surge arrester 10 of the embodiment shown in FIGS. 1 and 2, hence in the following only the differences are described:

In the exemplary surge arrester 10 of FIGS. 3 and 4, the arrangement of the spring 38 for compensating thermal expansion of the arrester element 14 is different. Instead of arranging the spring 38 on the side 28 of the electrode 12a facing away from the arrester element 14, the spring 38 is arranged on the side 32 of the electrode 12a facing towards the arrester element 14.

The single spring 38 used in this embodiment is in direct contact with the electrode 12a and further with a connecting element 42 arranged next to the arrester element 14. The connecting element 42 provides a support area for the spring 38, and further provides electrical connection to the electrode 12a. For this, the end electrode 12a comprises in the central through hole 40 a pin 44 which also engages with the connecting element 42. Furthermore, in this embodiment, the connecting element 42 also replaces the spacer element 30 next to the upper end electrode 12a as compared to the embodiment shown in FIGS. 1 and 2.

FIG. 5 schematically shows different views of a surge arrester 10 according to another embodiment of the present disclosure. The surge arrester 10 of this embodiment does not comprise multiple reinforcement rods 18 arranged around the arrester elements 14, but comprises one reinforcement rod 18 running through the arrester elements 14 arranged in between the two end electrodes 12a, 12b. Hence, in this embodiment not only the end electrodes 12a, 12b comprise the central through hole 40, but also the arrester elements 14 comprise a central through hole 40. Furthermore, the surge arrester 10 comprises an insulating tube around the reinforcement rod 18 to protect the reinforcement rod 18 from scratching. The clamping arrangement 20 and the spring 38 are arranged and configured like the clamping arrangement 20 and spring 38 shown in the embodiment in FIGS. 1 and 2.

FIG. 6 schematically shows a surge arrester 10 according to a further embodiment of the present disclosure. In this embodiment and similar to the embodiment of FIG. 5, the surge arrester 10 comprises one reinforcement rod 18 running through the arrester elements 14 arranged in between the two end electrodes 12a, 12b. Furthermore, the surge arrester 10 also comprises the insulating tube around the reinforcement rod 18 to protect the reinforcement rod 18 from scratching. However, compared to the embodiment of FIG. 5, the arrangement of the spring 38 is different: In this embodiment the spring 38 is arranged on the side 32 of the electrode 12a facing towards the arrester element 14, just like in the exemplary surge arrester 10 of FIGS. 3 and 4.

While the present disclosure has been illustrated and described in detail in the drawings and foregoing description, such illustration and description are to be considered illustrative or exemplary and not restrictive. Other variations to be disclosed embodiments can be understood and effected by those skilled in the art in practicing the claimed invention, from a study of the drawings, the disclosed, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

10 surge arrester
12a, 12b end electrode
14 arrester element
16 axial direction
18 reinforcement rod
20 clamping arrangement
22 groove
24 retaining ring
26 through hole
28 side of electrode facing away from arrester
30 spacer element
32 side of electrode facing towards from arrester
34 annular fitting
36 sidewall
38 element for compensating thermal expansion, spring
40 central through hole
42 connecting element
44 pin

1. A surge arrester for high or medium voltage comprising:
two end electrodes,
arrester elements of metal oxide varistor material,
at least one reinforcement rod for axial compression of the arrester elements arranged in between the two electrodes in axial direction, and a clamping arrangement for anchoring the end electrodes to the reinforcement rod,
wherein the reinforcement rod comprises in an end region of the reinforcement rod a groove for engaging with a retaining ring of the clamping arrangement, and
wherein the surge arrester comprises for each reinforcement rod an element for compensating thermal expansion of the arrester elements.

2. The surge arrester according to claim 1, wherein in an end region of the reinforcement rod, the reinforcement rod is free of a screw thread and/or wherein the clamping arrangement is threadless.

3. The surge arrester according to claim 1, wherein the arrester elements are arranged as a stack in axial direction in between the two end electrodes, and wherein a spacer element is arranged in between the end electrode and the stack.

4. The surge arrester according to claim 1, wherein the surge arrester comprises multiple reinforcement rods, wherein the reinforcement rods connect the two end electrodes in axial direction with each other and surround the arrester elements arranged in between the two electrodes.

5. The surge arrester according to claim 1, wherein the end electrode comprises at least one through holes through which the reinforcement rod runs, such that the groove of the reinforcement rod is positioned on the side of the end electrode facing away from the arrester elements arranged in between the two electrodes.

6. The surge arrester according to claim 1, wherein the clamping arrangement comprises the retaining ring and an annular fitting, and with regard to the axial direction the annular fitting is arranged in between the retaining ring and the electrode.

7. The surge arrester according to claim 1, wherein the surge arrester comprises a plurality of reinforcement rods and a plurality of elements for compensating thermal expansion of the arrester elements.

8. The surge arrester according to claim 1, wherein the element for compensating thermal expansion of the arrester elements is arranged on the side of the end electrode facing away from the arrester elements arranged in between the two electrodes.

9. The surge arrester according to claim 1, wherein the element for compensating thermal expansion of the arrester elements is arranged on the side of the end electrode facing towards the arrester elements arranged in between the two electrodes.

10. The surge arrester according to claim 1, wherein the element for compensating thermal expansion of the arrester elements is arranged in between the end electrode and the clamping arrangement.

11. The surge arrester according to claim 1, wherein the surge arrester comprises at least one stabilizing disc in between two arrester elements, wherein the stabilizing disc comprises a through hole through which the reinforcement rod runs.

12. The surge arrester according to claim 1, wherein the arrester elements have a cylindrical or polygonal form.

13. The surge arrester according to claim 1, wherein the metal oxide varistor material comprises ZnO.

14. The surge arrester according to claim 1, wherein the surge arrester comprises an outer housing, preferably such that a gas volume remains in the interior of the outer housing.
